(19) United States
(12) Patent Application Publication
(10) Pub. No.: US 2022/0274383 A1
(43) Pub. Date: Sep. 1, 2022

(54) MULTILAYER FILMS AND ARTICLES COMPRISING MULTILAYER FILMS

(71) Applicant: Dow Global Technologies LLC, Midland, MI (US)

(72) Inventors: Justice Alaboson, Rosharon, TX (US); Vivek Kalihari, Missouri City, TX (US)

(21) Appl. No.: 17/597,914

(22) PCT Filed: Jun. 29, 2020
(86) PCT No.: PCT/US2020/040056

§ 371 Date: Jan. 28, 2022

Related U.S. Application Data
(60) Provisional application No. 62/880,833, filed on Jul. 31, 2019.

(51) Int. Cl. B32B 27/08; B32B 7/02; B32B 27/32; B32B 27/28; B32B 1/00; B65D 65/40

(52) U.S. Cl. CPC B32B 27/08; B32B 7/02; B32B 27/32; B32B 27/283; B32B 1/00; B65D 65/40; B32B 2307/72; B32B 2307/546; B32B 2307/58; B32B 2270/00; B32B 2439/06; B32B 2250/40; B32B 2250/24

(57) ABSTRACT

Embodiments of the present invention relate to multilayer films, bags, and other articles. In one aspect, a multilayer film comprises a first skin layer having an overall density of less than or equal to 0.912 g/cm³; a second skin layer having an overall density of less than or equal to 0.912 g/cm³; and a core positioned between the skin layers, wherein the core has an overall density that is at least 0.01 g/cm³ greater than then overall density of the first skin layer, wherein the overall density of the multilayer film is from 0.905 to 0.930 g/cm³, wherein the film has a bending stiffness of 1.35 mN·mm or less when the film has a thickness of 2 mils (50.8 microns), wherein the film exhibits a Gelbo flex crack performance of 2 pinholes or less in 20,000 cycles, and wherein the film comprises at least 95% by weight polyethylene based on the total weight of the film.

### FIELD

This disclosure relates to multilayer films and to articles comprising multilayer films.

### INTRODUCTION

Bag-in-box flexible liquid packages (“BIB packages”) in all formats (e.g., Intermediate Bulk Containers (IBC), flexi-tanks) are used to hold a variety of liquids. These bags can typically hold from 0.5 gallon up to 6,000 gallons of liquid, such as food (e.g. juices and other beverages, sauces, condiments, etc.) and industrial liquids. As interest in BIB packages grows, more attention will be paid to the performance of such packages under a variety of conditions, ranging from filling through handling, transportation and storage. Film structures for BIB packages typically range from monolayer to multilayer films consisting of polyethylene and other materials (e.g., polyamide, ethylene vinyl alcohol, metallized polyethylene terephthalate) depending on the product that is to be packaged and/or the performance that is required.

For large format bags (e.g., 250 gallons or greater), defects in the bag typically occur during transportation. For example, pinholes typically originate at high stress regions (e.g., near the water or liquid line) where the most intense film flexing is seen. Leakage through these pinholes typically results in material loss, cargo rejection, and/or costly clean ups. There are several approaches to reduce the risk caused by pinholes. These include the use of multiple plys for a single bag, and even the use of dunnage systems, which can add significant cost in terms of material and labor.

Many applications require a certain level of flex crack performance, typically measured using Gelbo flex crack resistance. For some of the most demanding applications, a Gelbo flex crack resistance of two or less pinholes in 20,000 cycles is desired. To achieve such performance, some film converters have been exploring the use of complex film structures consisting of multi-component materials. Multi-component structures have, in general, higher raw material costs than all polyethylene structures. In addition to costs, not all film converters are equipped to run non-polyethylene materials as some materials require special extrusion equipment which may have special maintenance needs. In addition, there may be product losses due to a film structure being out of specification as manufacturing lines are purged when transitioning from one film structure to the other.

There remains a need for new film structures that can provide improved flex crack performance.

### SUMMARY

The present invention provides multilayer films that can be used, in some embodiments, packaging for liquids. Such multilayer films are advantageously formed substantially from polyethylene (e.g., at least 95% by weight polyethylene). According to some embodiments, multilayer films of the present invention can provide desirable flex crack performance when incorporated into bags while being formed substantially from polyethylene. Such embodiments advantageously provide a high level of flex crack resistance while being highly recyclable, which represents a high performing solution that is also sustainable.

In one aspect, the present invention provides a multilayer film that comprises a first skin layer having an overall density of less than or equal to 0.912 g/cm³; a second skin layer having an overall density of less than or equal to 0.912 g/cm³; and a core positioned between the skin layers, wherein the core has an overall density that is at least 0.01 g/cm³ greater than then overall density of the first skin layer, wherein the overall density of the multilayer film is from 0.905 to 0.930 g/cm³, wherein the film has a bending stiffness of 1.35 mN·mm or less when the film has a thickness of 2 mils (50.8 microns), wherein the film exhibits a Gelbo flex crack performance of 2 pinholes or less in 20,000 cycles, and wherein the film comprises at least 95% by weight polyethylene based on the total weight of the film.

As discussed below, the present invention also provides bags and other articles formed from any of the inventive multilayer films disclosed herein.

These and other embodiments are described in more detail in the Detailed Description.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount (>50 mol %) of units derived from ethylene monomer, and the remaining units derived from one or more α-olefins. Typical α-olefins used in forming ethylene/α-olefin interpolymers are C₃-C₁₀ alkenes.

The term, “ethylene/α-olefin copolymer,” as used herein, refers to a copolymer that comprises, in polymerized form, a majority amount (>50 mol %) of ethylene monomer, and an α-olefin, as the only two monomer types.

The term “α-olefin”, as used herein, refers to an alkene having a double bond at the primary or alpha (a) position.

“Polyethylene” or “ethylene-based polymer” shall mean polymers comprising a majority amount (>50 mol %) of units which have been derived from ethylene monomer. This includes polyethylene homopolymers, ethylene/α-olefin interpolymers, and ethylene/α-olefin copolymers. Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); Medium Density Polyethylene (MDPE); High Density Polyethylene (HDPE); Enhanced Polyethylene; polyethylene elastomers; and polyethylene plastomers. These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”), constrained geometry catalysts (CGC), and molecular catalysts. Resins include linear, substantially linear, or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts, constrained geometry catalysts, and molecular catlysts, and typically have a molecular weight distribution (“MWD”) greater than 2.5.

The term “HDPE” refers to polyethylenes having densities greater than about 0.935 g/cm³ and up to about 0.970 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, chrome catalysts, or single-site catalysts including, but not limited to, bis-metallocene catalysts and constrained geometry catalysts.

“Polyethylene plastomers/elastomers” are substantially linear, or linear, ethylene/α-olefin copolymers containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. Polyethylene plastomers/elastomers have a density from 0.870 g/cm³, or 0.880 g/cm³, or 0.890 g/cm³ to 0.900 g/cm³, or 0.902 g/cm³, or 0.904 g/cm³, or 0.909 g/cm³, or 0.910 g/cm³, or 0.917 g/cm³. Nonlimiting examples of polyethylene plastomers/elastomers include AFFINITY™ plastomers and elastomers (available from The Dow Chemical Company), EXACT Plastomers (available from ExxonMobil Chemical), Tafmer (available from Mitsui), Nexlene™ (available from SK Chemicals Co.), and Lucene (available LG Chem Ltd.).

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

In one aspect, the present invention provides a multilayer film that comprises a first skin layer having an overall density of less than or equal to 0.912 g/cm³; a second skin layer having an overall density of less than or equal to 0.912 g/cm³; and a core positioned between the skin layers, wherein the core has an overall density that is at least 0.01 g/cm³ greater than then overall density of the first skin layer, wherein the overall density of the multilayer film is from 0.905 to 0.930 g/cm³, wherein the film has a bending stiffness of 1.35 mN·mm or less when the film has a thickness of 2 mils (50.8 microns), wherein the film exhibits a Gelbo flex crack performance of 2 pinholes or less in 20,000 cycles, and wherein the film comprises at least 95% by weight polyethylene based on the total weight of the film. In some embodiments, the second skin layer has the same composition as the first skin layer.

In some embodiments, the first skin layer comprises a polyethylene plastomer or a polyethylene elastomer. In some embodiments, the second skin layer comprises a polyethylene platomer or a polyethylene elastomer.

In some embodiments, at least one skin layer further comprises from 0.5 wt % to 5.0 wt % polydimethylsiloxane, based on the total weight of the skin layer. In some embodiments, at least one skin layer comprises a polyethylene plastomer or a polyethylene elastomer and from 0.5 wt % to 5.0 wt % polydimethylsiloxane, based on the total weight of the skin layer.

In some embodiments, at least one skin layer further comprises a blend comprising (i) a first polydimethylsiloxane having a number average molecular weight (Mₙ) from 30,000 g/mol to less than 300,000 g/mol and (ii) a second polydimethylsiloxane having a number average molecular weight (Mₙ) from 300,000 g/mol to 2,000,000 g/mol, wherein the skin layer comprises from 0.01 to 2.5 weight percent of the first polydimethylsiloxane based on the total weight of the skin layer and from 0.05 to 4.95 weight percent of the second polydimethylsiloxane based on the total weight of the skin layer. In some embodiments, at least one skin layer comprises a polyethylene plastomer or a polyethylene elastomer and a blend comprising (i) a first polydimethylsiloxane having a number average molecular weight (Mₙ) from 30,000 g/mol to less than 300,000 g/mol and (ii) a second polydimethylsiloxane having a number average molecular weight (Mₙ) from 300,000 g/mol to 2,000,000 g/mol, wherein the skin layer comprises from 0.01 to 2.5 weight percent of the first polydimethylsiloxane based on the total weight of the skin layer and from 0.05 to 4.95 weight percent of the second polydimethylsiloxane based on the total weight of the skin layer.

In some embodiments, the thickness of the core comprises up to 80% of the thickness of the multilayer film. The thickness of the core, in some embodiments, comprises at least 40% and up to 80% of the thickness of the multilayer film. In some embodiments, the overall thickness of the film is from 1 mil (25.4 microns) to 10 mils (254 microns).

The multilayer film is a three layer film (i.e., the core is a single layer) in some embodiments. In some embodiments, the core comprises two or more layers.

In some embodiments, the multilayer film comprises an olefin block copolymer in at least one of the layers.

A multilayer film of the present invention can comprise a combination of two or more embodiments as described herein.

Some embodiments of the present invention relate to articles. An article according to embodiments of the present invention comprises a multilayer film according to any of the inventive embodiments disclosed herein. An article of the present invention can comprise a combination of two or more embodiments as described herein.

Some embodiments of the present invention relate to bags. A bag according to embodiments of the present invention comprises a multilayer film according to any of the inventive embodiments disclosed herein. A bag of the present invention can comprise a combination of two or more embodiments as described herein.

Multilayer films according to the present invention comprise a first skin layer, a second skin layer, and a core. The first and second skin layers each have an overall density of less than or equal to 0.912 g/cm³. The core is positioned between the skin layers and has an overall density of at least 0.01 g/cm³ greater than the overall density of the first skin layer.

Multilayer films of the present invention are advantageously comprised almost entirely of polyethylene. For example, in some embodiments, other than additives, the multilayer film is comprised entirely of polyethylene. Based on the total weight of the multilayer film, the multilayer film may include 95% by weight polyethylene in some embodiments, or 97% by weight polyethylene in some embodiments, or 99% by weight polyethylene in some embodiments, or 99.9% by weight polyethylene in some embodiments, or 100% by weight polyethylene in some embodiments.

### Skin Layers

With regard to the skin layers, the first skin layer and the second skin layer each have an overall density of less than or equal to 0.912 g/cm³. All individual values and subranges from less than or equal to 0.912 g/cm³ are included and disclosed herein. For example, the overall density of each skin layer can be equal to or less than 0.912 g/cm³, or in the alternative, equal to or less than 0.910 g/cm³, or in the alternative, equal to or less than 0.905 g/cm³, or in the alternative, equal to or less than 0.900 g/cm³. In some embodiments, each skin layer has an overall density of 0.875 g/cm³ or more. All individual values and subranges from 0.875 g/cm³ are included and disclosed herein; for example the overall density of each skin layer can be equal to or greater than 0.875 g/cm³, or in the alternative, equal to or greater than 0.880 g/cm³, or in the alternative, equal to or greater than 0.890 g/cm³, or in the alternative, equal to or greater than 0.895 g/cm³.

In some embodiments, the skin layers are formed from one polyethylene. The skin layers, in some embodiments, are formed from a blend of polyethylenes providing the specified overall density. The overall density of a layer formed from a blend of polyethylenes is the weighted sum of the densities of the individual resins that make up the layer.

In some embodiments, the one or more polyethylenes used in the skin layers have a melt index (I₂) of 8 g/10 minutes or less. All individual values and subranges up to 8 g/10 minutes are included herein and disclosed herein. For example, the one or more polyethylenes can have a melt index from a lower limit of 0.1, 0.2, 0.25, 0.3, 0.4 0.5, 0.75, 0.8, 0.9, 1, 1.5, or 2 g/10 minutes to an upper limit of 1, 2, 2.5, 3, 3.5, 4, 4.5, 5, 6, 7, or 8 g/10 minutes. In some embodiments, the one or more polyethylenes used in the skin layer have a melt index (I₂) of 5 g/10 minutes or less, or 2 g/10 minutes or less.

Polyethylenes that are particularly well-suited for use in the skin layers of some embodiments of the present invention include, without limitation, low density polyethylene (LDPE), polyethylene plastomer/elastomer, linear low density polyethylene (LLDPE), medium density polyethylene (MDPE), high density polyethylene (HDPE), other ethylene-based polymers (e.g., enhanced polyethylene) having a density from 0.865 g/cm³ to 0.970 g/cm³, olefin block copolymers, and combinations thereof. In view of the overall density of the skin layers needing to be 0.912 g/cm³ or less, the skin layers will primarily comprise ethylene-based polymers having lower densities such as polyethylene plastomers/elastomers, low density polyethylene, and linear low density polyethylene.

Various commercially available polyethylenes are contemplated for use as polyolefins in some embodiments of the present invention. Examples of commercially available polyethylene plastomers/elastomers that can be used in embodiments of the present invention include those available from The Dow Chemical Company under the names AFFINITY™ and ENGAGE™, such as AFFINITY™ PL 1880G. Examples of commercially available LDPE that can be used in embodiments of the present invention include those available from The Dow Chemical Company under the names DOW LDPE™ and AGILITY™. Examples of commercially available LLDPE that can be used in embodiments of the present invention include DOWLEX™ linear low density polyethylene commercially available from The Dow Chemical Company. Examples of commercially available olefin block copolymers that can be used in embodiments of the present invention include those commercially available from The Dow Chemical Company under the name INFUSE™. Examples of other commercially available ethylene-based polymers having a density from 0.865 to 0.970 g/cm³ that can be used in some embodiments include those available from The Dow Chemical Company under the names ELITE™, ELITE™ AT, and INNATE™.

Persons having an ordinary skill in the art will recognize that a variety of polyethylene resins and combinations of such resins can be selected so as to provide skin layers having densities of 0.912 g/cm³ or less.

In some embodiments, small amounts of propylene-based resins can be included in the skin layer such as propylene-ethylene copolymers. The amount of such propylene-ethylene copolymers to include can depend for example on the target density for the skin layer and/or the target overall polyethylene content for the films. Examples of commercially available propylene-ethylene copolymers that can be used in embodiments of the present invention include those commercially available from The Dow Chemical Company under the name VERSIFY™.

In an embodiment, the skin layer comprises a polyethylene plastomer/elastomer. The polyethylene plastomer/elastomer is an ethylene/α-olefin copolymer consisting of units derived from ethylene and a C₃-C₁₀ α-olefin comonomer, or a C₄-C₈ α-olefin comonomer, or a C₆-C₈ α-olefin comonomer and optional additives. In an embodiment, the polyethylene plastomer/elastomer is an ethylene/C₄-C₈ α-olefin copolymer having one, some, or all of the following properties:
(a) a density from 0.870 g/cm³, or 0.880 g/cm³, or 0.890 g/cm³ to 0.900 g/cm³, or 0.902 g/cm³, or 0.904 g/cm³, or 0.909 g/cm³, or 0.910 g/cm³, or 0.917 g/cm³; and/or
(b) a melt index from a melt index from 0.1 g/10 min, or 1 g/10 min to 1.5 g/10 min, or 2.0 g/10 min, or 3.0 g/10 min, or 5.0 g/10 min, or 6.0 g/10 min, or 8.0 g/10 min, or 10 g/10 min, or 15 g/10 min, or 20 g/10 min, or 30 g/10 min, or 40 g/10 min, or 50 g/10 min, or 100 g/10 min, or 150 g/10 min, or 200 g/10 min, or 250 g/10 min, or 300 g/10 min; and/or
(c) a melting point (Tm) from 40° C., or 45° C., or 50° C., or 55° C., or 60° C., or 65° C., or 70° C., or 75° C. to 80° C., or 85° C., or 90° C., or 95° C., or 100° C., or 105° C., or 110° C., or 115° C., or 120° C.
   In an embodiment, the polyethylene plastomer/elastomer is an ethylene/α-olefin copolymer with a density of 0.902 g/cm³, a melt index of 1.0 g/10 min, and a melting point of 99° C. (e.g., AFFINITY™ PL 1880G, available from The Dow Chemical Company).

In some embodiments where a skin layer comprises a polyethylene plastomer/elastomer, the skin layer may contain more than one ethylene-based polymer. In an embodiment, a skin layer includes at least two ethylene-based polymers, wherein each ethylene-based polymer differs from one another compositionally, structurally, and/or physically. In an embodiment, the skin layer contains a polyethylene plastomer/elastomer and a LDPE. In another embodiment, the skin layer contains a polyethylene plastomer/elastomer and a LLDPE.

Slip Agent Blends

In some embodiments, one or both skin layers comprise a slip agent blend. In such embodiments, the slip agent blend contains (i) a first polydimethylsiloxane having a number average molecular weight (Mn) from 30,000 g/mol to less than 300,000 g/mol; and (ii) a second polydimethylsiloxane having a number average molecular weight (Mn) from 300,000 g/mol to 2,000,000 g/mol, based on the total weight of the slip agent blend. “Polydimethylsiloxane” (“PDMS”) is a polymeric organosilicon compound with the following general Structure (I):

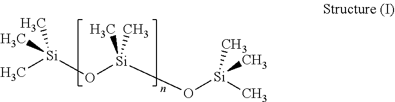

wherein n is the number of repeating monomer [SiO(CH₃)₂] units and n is greater than or equal to 2, or from 2 to 20,000. The PDMS may be unsubstituted or substituted. A “substituted PDMS” is a PDMS in which at least one methyl group of Structure (I) is substituted with a substituent. Nonlimiting examples of substituents include halogen atoms (such as chlorine, fluorine, bromine, and iodine); halogen atom-containing groups (such as chloromethyl groups, perfluorobutyl groups, trifluoroethyl groups, and nonafluorohexyl groups); oxygen atom-containing groups (such as hydroxy groups, alkoxy groups (such as methoxy groups and ethoxy groups), (meth)acrylic epoxy groups, and carboxyl groups); nitrogen atom-containing groups (such as amino-functional groups, amido-functional groups, and cyano-functional groups); sulphur atom-containing groups (such as mercapto groups); hydrogen; C₂-C₁₀ alkyl groups (such as an ethyl group); C₂-C₁₀ alkynyl groups; alkenyl groups (such as vinyl groups and hexenyl groups); aryl groups (such as phenyl groups and substituted phenyl groups); cycloalkyl groups (such as cyclohexane groups); and combinations thereof. The substituted methyl group may be a terminal methyl group or a non-terminal methyl group. Nonlimiting examples of suitable substituted PDMS include trialkylsilyl terminated PDMS wherein at least one alkyl is a C₂-C₁₀ alkyl; dialkylhydroxysilyl terminated PDMS; dialkylhydrogensilyl terminated PDMS; dialkylalkenyl silyl terminated PDMS; and dialkylvinylsilyl terminated PDMS. In an embodiment, the substituted PDMS is a dimethylhydroxysilyl terminated PDMS. In another embodiment, the substituted PDMS is a dimethylvinylsilyl terminated PDMS. In an embodiment, the substituted PDMS excludes nitrogen atom-containing groups. In another embodiment, the substituted PDMS excludes epoxy substituent groups. In an embodiment, the PDMS is unsubstituted. An “unsubstituted PDMS” is the PDMS of Structure (I) wherein no methyl group in Structure (I) is substituted with a substituent. In an embodiment, the unsubstituted PDMS is a trimethylsilyl terminated PDMS.

(i) First Polydimethylsiloxane

The slip agent blend contains a first polydimethylsiloxane having a number average molecular weight (Mn) from 30,000 g/mol to less than 300,000 g/mol (a “low Mn” PDMS). In an embodiment, the first PDMS (i.e., the low Mn PDMS) has a number average molecular weight (Mn) from 30,000 g/mol, or 40,000 g/mol, or 45,000 g/mol, or 48,000 g/mol to 49,000 g/mol, or 50,000 g/mol, or 55,000 g/mol, or 60,000 g/mol, or 65,000 g/mol, or 70,000 g/mol, or 75,000 g/mol, or 80,000 g/mol, or 90,000 g/mol, or 100,000 g/mol, or 150,000 g/mol, or 200,000 g/mol, or 250,000 g/mol, or 290,000 g/mol, or less than 300,000 g/mol. In an embodiment, the low Mn PDMS has a number average molecular weight (Mn) from 30,000 g/mol, or 35,000 g/mol, or 40,000 g/mol, or 45,000 g/mol, or 48,000 g/mol to 49,000 g/mol, or less than 50,000 g/mol.

In an embodiment, the low Mn PDMS has a weight average molecular weight (Mw) from 30,000 g/mol, or 40,000 g/mol, or 45,000 g/mol, or 50,000 g/mol, or 55,000 g/mol, or 60,000 g/mol, or 65,000 g/mol, or 70,000 g/mol, or 75,000 g/mol, or 80,000 g/mol, or 90,000 g/mol, or 100,000 g/mol, or 120,000 g/mol to 130,000 g/mol, or 140,000 g/mol, or 150,000 g/mol, or 200,000 g/mol, or 250,000 g/mol, or 290,000 g/mol, or less than 300,000 g/mol.

In an embodiment, the low Mn PDMS has a molecular weight distribution (Mw/Mn) from 1.0, or 1.5, or 2.0, or 2.1, or 2.2, or 2.3, or 2.4 to 2.5, or 2.6, or 2.7, or 2.8, or 2.9, or 3.0, or 3.5.

In an embodiment, the low Mn PDMS has the Structure (I) and n is from 2, or 5, or 10, or 50, or 100, or 150, or 200, or 250, or 300, or 350, or 400, or 450, or 500, or 550, or 600, or 650 to 700, or 750, or 800, or 850, or 900, or 950, or 1000, or 1100, or 1200, or 1300, or 1400, or 1500, or 1600, or 1700, or 1800, or 1900, or 2000, or 2500, or 3000, or 3500, or 4000, or 4054.

In an embodiment, the low Mn PDMS is a dimethylhydroxysilyl terminated PDMS. In an embodiment, the low Mn PDMS (such as a dimethylhydroxysilyl terminated PDMS) has a number average molecular weight (Mn) from 30,000 g/mol, or 35,000 g/mol, or 40,000 g/mol, or 45,000 g/mol, or 48,000 g/mol to 49,000 g/mol, or 50,000 g/mol; and the low Mn PDMS has one, some, or all of the following properties:

(a) a weight average molecular weight (Mw) from 50,000 g/mol, or 55,000 g/mol, or 60,000 g/mol, or 65,000 g/mol, or 70,000 g/mol, or 75,000 g/mol, or 80,000 g/mol, or 90,000 g/mol, or 100,000 g/mol, or 120,000 g/mol to 130,000 g/mol, or 150,000 g/mol; and/or

(b) a molecular weight distribution (Mw/Mn) from 2.2, or 2.3, or 2.4 to 2.5, or 2.6; and/or

(c) the low Mn PDMS has the Structure (I) and n is from 2, or 5, or 10, or 50, or 100, or 150, or 200, or 250, or 300, or 350, or 400, or 450, or 500, or 550, or 600, or 650 to 700, or 750, or 800, or 850, or 900, or 950, or 1000, or 1100, or 1200, or 1300, or 1400, or 1500, or 1600, or 1700, or 1800, or 1900, or 2000, or 2500, or 3000, or 3500, or 4000, or 4054.

The slip agent blend may contain more than one low Mn PDMS.

The first PDMS (i.e., the low Mn PDMS) may comprise two or more embodiments discussed herein.

(ii) Second Polydimethylsiloxane

The slip agent blend contains a second polydimethylsiloxane having a number average molecular weight (Mn) from 300,000 g/mol to 2,000,000 g/mol (a “high Mn” PDMS).

In an embodiment, the second PDMS (i.e., the high Mn PDMS) has a number average molecular weight (Mn) from 300,000 g/mol, or 310,000 g/mol, or 320,000 g/mol, or 330,000 g/mol, or 340,000 g/mol, or 350,000 g/mol to 360,000 g/mol, or 370,000 g/mol, or 380,000 g/mol, or 390,000 g/mol, or 400,000 g/mol, or 450,000 g/mol, or 500,000 g/mol, or 550,000 g/mol, or 600,000 g/mol, or 750,000 g/mol, or 1,000,000 g/mol, or 1,500,000 g/mol, or 2,000,000 g/mol. In an embodiment, the high Mn PDMS has a number average molecular weight (Mn) from 300,000 g/mol, or 310,000 g/mol, or 320,000 g/mol, or 330,000 g/mol, or 340,000 g/mol, or 350,000 g/mol to 360,000 g/mol, or 370,000 g/mol, or 380,000 g/mol, or 390,000 g/mol, or 400,000 g/mol, or 450,000 g/mol, or 500,000 g/mol, or 550,000 g/mol.

In an embodiment, the high Mn PDMS has a weight average molecular weight (Mw) from 350,000 g/mol, or 360,000 g/mol, or 370,000 g/mol, or 380,000 g/mol, or 390,000 g/mol, or 400,000 g/mol, or 450,000 g/mol, or 500,000 g/mol, or 600,000 g/mol, or 640,000 g/mol to 650,000 g/mol, or 700,000 g/mol, or 750,000 g/mol, or 800,000 g/mol, or 900,000 g/mol, or 1,000,000 g/mol, or 1,500,000 g/mol, or 2,000,000 g/mol.

In an embodiment, the high Mn PDMS has a molecular weight distribution (Mw/Mn) from 1.0, or 1.5, or 1.8 to 1.9, or 2.0, or 2.1, or 2.2, or 2.3, or 2.4, or 2.5, or 2.6, or 2.7, or 2.8, or 2.9, or 3.0.

In an embodiment, the high Mn PDMS has the Structure (I) and n is greater than 4054, or from 4054, or 4500 to 5000, or 5500, or 6000, or 6500, or 7000, or 7500, or 8000, or 8500, or 9000, or 9500, or 10000, or 11000, or 12000, or 13000, or 14000, or 15000, or 16000, or 17000, or 18000, or 19000, or 20000, or 21000, or 22000, or 23000, or 24000, or 25000, or 26000, or 27000, or 27027.

In an embodiment, the high Mn PDMS is a dimethylvinylsilyl terminated PDMS. In an embodiment, the high Mn PDMS (such as a dimethylvinylsilyl terminated PDMS) has a number average molecular weight (Mn) from 300,000 g/mol, or 310,000 g/mol, or 320,000 g/mol, or 330,000 g/mol, or 340,000 g/mol, or 350,000 g/mol to 360,000 g/mol, or 370,000 g/mol, or 380,000 g/mol, or 390,000 g/mol, or 400,000 g/mol, or 450,000 g/mol, or 500,000 g/mol, or 550,000 g/mol; and the high Mn PDMS has one, some, or all of the following properties:

(a) a weight average molecular weight (Mw) from 400,000 g/mol, or 450,000 g/mol, or 500,000 g/mol, or 600,000 g/mol, or 640,000 g/mol to 650,000 g/mol, or 700,000 g/mol, or 750,000 g/mol, or 800,000 g/mol, or 900,000 g/mol, or 1,000,000 g/mol; and/or

(b) a molecular weight distribution (Mw/Mn) from 1.5, or 1.8 to 1.9, or 2.0, or 2.1; and/or

(c) the high Mn PDMS has the Structure (I) and n is greater than 4054, or from 4054, or 4500 to 5000, or 5500, or 6000, or 6500, or 7000, or 7500, or 8000, or 8500, or 9000, or 9500, or 10000, or 11000, or 12000, or 13000, or 14000, or 15000, or 16000, or 17000, or 18000, or 19000, or 20000, or 21000, or 22000, or 23000, or 24000, or 25000, or 26000, or 27000, or 27027.

The slip agent blend may contain more than one high Mn PDMS.

The second PDMS (i.e., the high Mn PDMS) may comprise two or more embodiments discussed herein.

In some embodiments, one or both skin layers contain from 0.1 wt %, or 0.2 wt %, or 0.3 wt %, or 0.4 wt %, or 0.5 wt %, or 1.0 wt %, or 1.5 wt %, or 1.8 wt % to 2.0 wt %, or 2.3 wt %, or 2.5 wt %, or 2.8 wt %, or 3.0 wt %, or 3.5 wt %, or 4.0 wt %, or 4.5 wt %, or 5.0 wt % of the slip agent blend, based on the total weight of the skin layer. In another embodiment, one or both skin layers contain from 0.5 wt %, or 1.0 wt % to 1.5 wt %, or 2.0 wt %, or 2.5 wt % of the slip agent blend, based on the total weight of the skin layer. In another embodiment, the skin layer contains from 0.5 wt %, or 0.8 wt % to 1.0 wt %, or 1.5 wt %, or 2.0 wt %, or 2.5 wt % of the slip agent blend, based on the total weight of the skin layer. The first PDMS (i.e., the low Mn PDMS) and the second PDMS (i.e., the high Mn PDMS) may be included in the skin layer as part of a masterbatch in which one or both of the PDMS components is dispersed in a polymer matrix (such as a LDPE matrix). However, the amount of slip agent blend included in the skin layer refers only to the amount of the first PDMS (i.e., the low Mn PDMS) and the second PDMS (i.e., the high Mn PDMS) included in the skin layer, and excludes the weight of the polymer matrix of any PDMS masterbatch. In other words, the amount of slip agent blend refers to the combined amount of the first PDMS and the second PDMS included in the skin layer.

In an embodiment, the slip agent blend contains from 1 wt % to 99 wt % of the first PDMS (i.e., the low Mn PDMS) and a reciprocal amount, or from 1 wt % to 99 wt % of the second PDMS (i.e., the high Mn PDMS), based on the total weight of the slip agent blend (i.e., based on the combined amount of the first PDMS and the second PDMS). In another embodiment, the slip agent blend contains from 1 wt % to less than 50 wt % of the first PDMS and from greater than 50 wt % to 99 wt % of the second PDMS, based on the total weight of the slip agent blend. In an embodiment, the slip agent blend contains from 1 wt %, or 2 wt %, or 5 wt %, or 10 wt %, or 15 wt %, or 20 wt % to 25 wt %, or 30 wt %, or 35 wt %, or 40 wt %, or 45 wt %, or 49 wt %, or less than 50 wt % of the first PDMS, and a reciprocal amount of the second PDMS, or from greater than 50 wt %, or 51 wt %, or 55 wt %, or 60 wt %, or 65 wt %, or 70 wt %, or 75 wt % to 80 wt %, or 85 wt %, or 90 wt %, or 95 wt %, or 98 wt %, or 99 wt % of the second PDMS, based on the total weight of the slip agent blend. The combined amount of the first PDMS and the second PDMS yields a slip agent blend of 100 wt %.

In an embodiment, the skin layer contains from 0.01 wt %, or 0.05 wt %, or 0.10 wt %, or 0.20 wt %, or 0.30 wt %, or 0.40 wt %, or 0.50 wt % to 0.60 wt %, or 0.70 wt %, or 0.80 wt %, or 0.90 wt %, or 1.00 wt %, or 1.50 wt %, or 2.00 wt %, or 2.30 wt %, or 2.40 wt %, or less than 2.50 wt % of the first PDMS (i.e., the low Mn PDMS), based on the total weight of the skin layer.

In an embodiment, the skin layer contains from greater than 0.05 wt %, or 0.08 wt %, or 0.10 wt %, or 0.20 wt %, or 0.30 wt %, or 0.40 wt %, or 0.50 wt %, or 0.80 wt %, or 1.00 wt %, or 1.10 wt %, or 1.20 wt %, or 1.30 wt %, or 1.40 wt %, or 1.50 wt % to 1.60 wt %, or 1.70 wt %, or 1.80 wt %, or 1.90 wt %, or 2.00 wt %, or 2.50 wt %, or 3.00 wt %, or 3.50 wt %, or 4.00 wt %, or 4.50 wt %, or 4.95 wt % of the second PDMS (i.e., the high Mn PDMS), based on the total weight of the skin layer.

In an embodiment, the weight ratio of the second PDMS (i.e., the high Mn PDMS) to the first PDMS (i.e., the low Mn PDMS) is from 1.1:1, or 1.5:1, or 2.0:1, or 3.0:1 to 4.0:1, or 5.0:1, or 10:1, or 15:1, or 20:1, or 25:1, or 30:1, or 40:1, or 50:1, or 60:1, or 70:1, or 80:1, or 90:1, or 99:1. In an embodiment, the weight ratio of second PDMS to the first PDMS is 3:1.

The slip agent blend may comprise two or more embodiments discussed herein.

Optional Additive(s)

In an embodiment, one or both skin layers include one or more optional additives. Nonlimiting examples of suitable additives include antiblock agents, antioxidants, antistatic agents, stabilizing agents, nucleating agents, colorants, pigments, ultra violet (UV) absorbers or stabilizers, flame retardants, compatibilizers, plasticizers, fillers, processing aids, antifog additive, crosslinking agents (e.g., peroxides), and combinations thereof.

In an embodiment, the skin layer includes an antiblock agent. An “antiblock agent” is a compound that minimizes, or prevents, blocking (i.e., adhesion) between two adjacent layers of film by creating a microscopic roughening of the film layer surface, which reduces the available contact area between adjacent layers. The antiblock agent may be organic or inorganic. Nonlimiting examples of suitable antiblock agents include silica, talc, calcium carbonate, and combinations thereof. In an embodiment, the antiblock agent is silica (SiO₂). The silica may be organic silica or synthetic silica. In another embodiment, the antiblock agent is talc.

In an embodiment, one or both skin layers contain from 0 wt %, or 0.01 wt %, or 0.05 wt %, or 0.1 wt %, or 0.2 wt % to 0.3 wt %, or 0.4 wt %, or 0.5 wt %, or 1.0 wt %, or 2.0 wt %, or 3.0 wt %, or 4.0 wt %, or 5.0 wt % additive, based on the total weight of the skin layer.

In some embodiments, one or both skin layers comprise, consist essentially of, or consist of:

(A) from 70 wt %, or 75 wt %, or 80 wt %, or 85 wt %, or 90 wt % to 93 wt %, or 94 wt %, or 95 wt %, or 96 wt %, or 97 wt %, or 98 wt %, or 99 wt %, or 99.9 wt % ethylene-based polymer (such as a polyethylene plastomer/elastomer, a LDPE, a LLDPE, or combinations thereof), based on the total weight of the skin layer;

(B) from 0.1 wt %, or 0.2 wt %, or 0.3 wt %, or 0.4 wt %, or 0.5 wt %, or 1.0 wt %, or 1.5 wt %, or 1.8 wt % to 2.0 wt %, or 2.3 wt %, or 2.5 wt %, or 2.8 wt %, or 3.0 wt %, or 3.5 wt %, or 4.0 wt %, or 4.5 wt %, or 5.0 wt % slip agent blend, based on the total weight of the skin layer; and

(C) optionally, from 0 wt %, or 0.01 wt %, or 0.05 wt %, or 0.1 wt %, or 0.2 wt % to 0.3 wt %, or 0.4 wt %, or 0.5 wt %, or 1.0 wt %, or 2.0 wt %, or 3.0 wt %, or 4.0 wt %, or 5.0 wt % additive, based on the total weight of the skin layer; and the slip agent blend contains:
(i) from 1 wt %, 5 wt %, or 10 wt %, or 15 wt %, or 20 wt % to 25 wt %, or 30 wt %, or 35 wt %, or 40 wt %, or 45 wt %, or 49 wt %, or less than 50 wt % of a first PDMS (such as a dimethylhydroxysilyl terminated PDMS) having a Mn from 30,000 g/mol, or 40,000 g/mol, or 45,000 g/mol, or 48,000 g/mol to 49,000 g/mol, or 50,000 g/mol, or 55,000 g/mol, or 60,000 g/mol, or 65,000 g/mol, or 70,000 g/mol, or 75,000 g/mol, or 80,000 g/mol, or 90,000 g/mol, or 100,000 g/mol, or 150,000 g/mol, or 200,000 g/mol, or 250,000 g/mol, based on the total weight of the slip agent blend; and
(ii) from greater than 50 wt %, or 51 wt %, or 55 wt %, or 60 wt %, or 65 wt %, or 70 wt %, or 75 wt % to 80 wt %, or 85 wt %, or 90 wt %, or 95 wt %, or 99 wt % of a second PDMS (such as a dimethylvinylsilyl terminated PDMS) having a Mn from 300,000 g/mol, or 310,000 g/mol, or 320,000 g/mol, or 330,000 g/mol, or 340,000 g/mol, or 350,000 g/mol to 360,000 g/mol, or 370,000 g/mol, or 380,000 g/mol, or 390,000 g/mol, or 400,000 g/mol, or 450,000 g/mol, or 500,000 g/mol, or 550,000 g/mol, or 600,000 g/mol, or 750,000 g/mol, or 1,000,000 g/mol, based on the total weight of the slip agent blend.

In some embodiments, one or both skin layers comprise, consist essentially of, or consist of:

(1) from 70 wt %, or 75 wt %, or 80 wt %, or 85 wt %, or 90 wt % to 93 wt %, or 94 wt %, or 95 wt %, or 96 wt %, or 97 wt %, or 98 wt %, or 99 wt %, or 99.9 wt % ethylene-based polymer (such as a polyethylene plastomer/elastomer, a LDPE, a LLDPE, or combinations thereof), based on the total weight of the skin layer;

(2) from 0.01 wt %, or 0.05 wt %, or 0.10 wt %, or 0.20 wt %, or 0.30 wt %, or 0.40 wt %, or 0.50 wt % to 0.60 wt %, or 0.70 wt %, or 0.80 wt %, or 0.90 wt %, or 1.00 wt %, or 1.50 wt %, or 2.00 wt %, or 2.30 wt %, or 2.40 wt %, or less than 2.50 wt % of a first PDMS (such as a dimethylhydroxysilyl terminated PDMS) having a Mn from 30,000 g/mol, or 40,000 g/mol, or 45,000 g/mol, or 48,000 g/mol to 49,000 g/mol, or 50,000 g/mol, or 55,000 g/mol, or 60,000 g/mol, or 65,000 g/mol, or 70,000 g/mol, or 75,000 g/mol, or 80,000 g/mol, or 90,000 g/mol, or 100,000 g/mol, or 150,000 g/mol, or 200,000 g/mol, or 250,000 g/mol, based on the total weight of the skin layer;

(3) from greater than 0.05 wt %, or 0.08 wt %, or 0.10 wt %, or 0.20 wt %, or 0.30 wt %, or 0.40 wt %, or 0.50 wt %, or 0.80 wt %, or 1.00 wt %, or 1.10 wt %, or 1.20 wt %, or 1.30 wt %, or 1.40 wt %, or 1.50 wt % to 1.60 wt %, or 1.70 wt %, or 1.80 wt %, or 1.90 wt %, or 2.00 wt %, or 2.50 wt %, or 3.00 wt %, or 3.50 wt %, or 4.00 wt %, or 4.50 wt %, or 4.95 wt % of a second PDMS (such as a dimethylvinylsilyl terminated PDMS) having a Mn from 300,000 g/mol, or 310,000 g/mol, or 320,000 g/mol, or 330,000 g/mol, or 340,000 g/mol, or 350,000 g/mol to 360,000 g/mol, or 370,000 g/mol, or 380,000 g/mol, or 390,000 g/mol, or 400,000 g/mol, or 450,000 g/mol, or 500,000 g/mol, or 550,000 g/mol, or 600,000 g/mol, or 750,000 g/mol, or 1,000,000 g/mol, based on the total weight of the skin layer; and

(4) optionally, from 0 wt %, or 0.01 wt %, or 0.05 wt %, or 0.1 wt %, or 0.2 wt % to 0.3 wt %, or 0.4 wt %, or 0.5 wt %, or 1.0 wt %, or 2.0 wt %, or 3.0 wt %, or 4.0 wt %, or 5.0 wt % additive, based on the total weight of the skin layer; and the weight ratio of the first PDMS to the second PDMS is from 1.5:1, or 2.0:1, or 3.0:1 to 4.0:1, or 5.0:1, or 10:1, or 15:1, or 20:1, or 25:1, or 30:1, or 40:1, or 50:1, or 60:1, or 70:1, or 80:1, or 90:1, or 99:1.

In some embodiments, one skin layer comprises the above-described slip agent blend and the other does not.

In some embodiments, each skin layer has a thickness from 5 μm, or 7 μm, or 10 μm to 15 μm, or 20 μm, or 25 μm, or 30 μm, or 35 μm, or 40 μm, or 45 μm, or 50 μm.

Each skin layer may comprise two or more embodiments discussed herein.

### Core

Turning now to the core, the core is positioned between the skin layers and has an overall density of at least 0.01 g/cm³ greater than the overall density of the first skin layer. Without wishing to be bound by any particular theory, it is believed that this relationship between the densities of the first skin layer and the core enhances the flexibility of the film.

The core may be a single layer or may comprise multiple layers. When the core is a single core layer (i.e., the film is a three layer film), the core layer is in adhering contact with the first skin layer and the second skin layer. In some embodiments, the core comprises two or more layers. In some embodiments, the core comprises up to 11 layers. In some embodiments, the core comprises from 2 to 11 layers, or from 3 to 10 layers, or from 3 to 7 layers, or others.

The core has an overall density that is at least 0.01 g/cm³ greater than the first skin layer. In some embodiments, the core has an overall density that is at least 0.02 g/cm³ greater than the first skin layer. The core has an overall density that is at least 0.03 g/cm³ greater than the first skin layer in some embodiments.

In some embodiments, the core has an overall density of less than or equal to 0.950 g/cm³. All individual values and subranges from less than or equal to 0.950 g/cm³ are included and disclosed herein. For example, the overall density of the core can be equal to or less than 0.950 g/cm³, or in the alternative, equal to or less than 0.945 g/cm³, or in the alternative, equal to or less than 0.930 g/cm³, or in the alternative, equal to or less than 0.925 g/cm³, or in the alternative, equal to or less than 0.920 g/cm³. In some embodiments, the core has an overall density of 0.912 g/cm³ or more. All individual values and subranges from 0.912 g/cm³ are included and disclosed herein; for example the overall density of the core can be equal to or greater than 0.912 g/cm³, or in the alternative, equal to or greater than 0.914 g/cm³, or in the alternative, equal to or greater than 0.915 g/cm³.

In some embodiments, the core is formed from one polyethylene. The core, in some embodiments, is formed from a blend of polyethylenes providing the specified overall density (e.g., a single layer formed from a blend of polyethylenes, multiple layers with at least two of the layers being formed from different polyethylenes, multiple layers with each layer being formed from a blend of polyethylenes, multiple layers with one or more layers formed from a single polyethylene and one or more layers formed from a blend of polyethylenes, etc.). The overall density of the core is the weighted sum of the densities of the individual resins that make up the core.

In some embodiments, the one or more polyethylenes used in the core have a melt index (I₂) of 8 g/10 minutes or less. All individual values and subranges up to 8 g/10 minutes are included herein and disclosed herein. For example, the one or more polyethylenes can have a melt index from a lower limit of 0.1, 0.2, 0.25, 0.3, 0.4 0.5, 0.75, 0.8, 0.9, 1, 1.5, or 2 g/10 minutes to an upper limit of 1, 2, 2.5, 3, 3.5, 4, 4.5, 5, 6, 7, or 8 g/10 minutes. In some embodiments, the one or more polyethylenes used in the core layer have a melt index (I₂) of 5 g/10 minutes or less, or 2 g/10 minutes or less.

Polyethylenes that are particularly well-suited for use in the core of some embodiments of the present invention include, without limitation, low density polyethylene (LDPE), polyethylene plastomer/elastomer, linear low density polyethylene (LLDPE), medium density polyethylene (MDPE), high density polyethylene (HDPE), other ethylene-based polymers (e.g., enhanced polyethylene) having a density from 0.865 g/cm³ to 0.970 g/cm³, olefin block copolymers, and combinations thereof.

Examples of commercially available HDPE that can be used in embodiments of the present invention include those available from The Dow Chemical Company under the names DOW™ HDPE resins. The polyethylenes used in the core in some embodiments can also include enhanced polyethylenes. Examples of commercially available enhanced polyethylene resins include ELITE™ and ELITE™ AT enhanced polyethylenes, such as ELITE™ 5960G1, ELITE™ 5400, and ELITE™ AT 6410 which are commercially available from The Dow Chemical Company. Examples of other polyethylenes that can be used in some embodiments of the present invention are INNATE™ polyethylene resins available from The Dow Chemical Company, such as INNATE™ ST50, INNATE™ ST70, and INNATE™ TH60. Persons of skill in the art can select other suitable commercially available polyethylenes for use in polymer blends based on the teachings herein. Examples of commercially available olefin block copolymers that can be used in embodiments of the present invention include those commercially available from The Dow Chemical Company under the name INFUSE™ such as, for example, INFUSE™ 9000, INFUSE™ 9007, INFUSE™ 9500, and INFUSE™ 9530.

Various commercially available polyolefin elastomers and polyolefin plastomers can also be used in the core in some embodiments of the present invention. Examples of commercially available polyolefin elastomers and polyolefin plastomers that can be used in embodiments of the present invention include those available from The Dow Chemical Company under the names AFFINITY™ and ENGAGE™.

In some embodiments, the core comprises up to 80% of the total thickness of the multilayer film. In some embodiments, the core comprises 40% or more of the total thickness of the multilayer film. In some embodiments, the core comprises from 40% to 80%, or from 50% to 70%, or from 60% to 80%, of the total thickness of the multilayer film.

In some embodiments, the core (either a single core layer, or any layer within the core when the core comprises multiple layers) includes one or more optional additives. Nonlimiting examples of suitable additives include antiblock agents, antioxidants, antistatic agents, stabilizing agents, nucleating agents, colorants, pigments, ultra violet (UV) absorbers or stabilizers, flame retardants, compatibilizers, plasticizers, fillers, processing aids, antifog additive, crosslinking agents (e.g., peroxides), and combinations thereof.

### Multilayer Films

As discussed herein, multilayer films of the present invention comprise two skin layers and a core, with the core comprising one or more layers in various embodiments.

Multilayer films of the present invention can comprise up to 13 layers in some embodiments. In various embodiments, the multilayer film comprises 3, 4, 5, 6, 7, 8, 9, 10, 11, 12, or 13 layers.

In some embodiments, the multilayer film is a three layer film. In one such embodiment, the first skin layer comprises a polyethylene plastomer or elastomer, with the first skin layer having an overall density of less than or equal to 0.912 g/cm³, the second skin layer has an overall density of less than or equal to 0.912 g/cm³, and the core layer has an overall density that is at least 0.01 g/cm³ greater than then overall density of the first skin layer, wherein the overall density of the multilayer film is from 0.905 to 0.930 g/cm³. In some embodiments, the second skin layer comprises a polyethylene plastomer or elastomer. In some embodiments, the first and/or the second skin layer further comprise a blend comprising (i) a first polydimethylsiloxane having a number average molecular weight (Mₙ) from 30,000 g/mol to less than 300,000 g/mol and (ii) a second polydimethylsiloxane having a number average molecular weight (Mₙ) from 300,000 g/mol to 2,000,000 g/mol, wherein the skin layer comprises from 0.01 to 2.5 weight percent of the first polydimethylsiloxane based on the total weight of the skin layer and from 0.05 to 4.95 weight percent of the second polydimethylsiloxane based on the total weight of the skin layer. In some embodiments, the overall density of the core layer is 0.920 g/cm³ or less.

In another embodiment wherein the multilayer film is a three layer film, the first skin layer comprises a polyethylene plastomer or elastomer, with the first skin layer having an overall density of less than or equal to 0.912 g/cm³, the second skin layer comprises a polyethylene plastomer or elastomer, with the second skin layer having an overall density of less than or equal to 0.912 g/cm³, and the core layer has an overall density from 0.913 g/cm³ to 0.920 g/cm³, wherein the first and the second skin layer each comprise a blend comprising (i) a first polydimethylsiloxane having a number average molecular weight (Mₙ) from 30,000 g/mol to less than 300,000 g/mol and (ii) a second polydimethylsiloxane having a number average molecular weight (Mₙ) from 300,000 g/mol to 2,000,000 g/mol, wherein each skin layer comprises from 0.01 to 2.5 weight percent of the first polydimethylsiloxane based on the total weight of the skin layer and from 0.05 to 4.95 weight percent of the second polydimethylsiloxane based on the total weight of the skin layer.

In another embodiment wherein the multilayer film is a three layer film, the first skin layer comprises a polyethylene plastomer or elastomer, with the first skin layer having an overall density of less than or equal to 0.912 g/cm³, the second skin layer comprises a polyethylene plastomer or elastomer, with the second skin layer having an overall density of less than or equal to 0.912 g/cm³, and the core layer has an overall density from 0.913 g/cm³ to 0.920 g/cm³, wherein the overall density of the multilayer film is from 0.905 to 0.930 g/cm³.

In some embodiments, the multilayer film has an overall density from 0.905 to 0.930 g/cm³. The overall density of the multilayer film is calculated from the weighted sum of the densities of the individual layers. Each layer density is calculated from the weighted sum of the individual resins that make up the layer. In some embodiments, the multilayer film has an overall density from 0.910 to 0.925 g/cm³.

In some embodiments, the multilayer film has a total thickness of from 1 mil (25.4 microns) to 10 mils (254 microns).

Multilayer films of the present invention exhibit one or more desirable properties. For example, in some embodiments, multilayer films can exhibit desirable bending stiffness, desirable Gelbo flex crack performance, and/or others. Such properties are particularly advantageous in a film that is highly recyclable (e.g., greater than 95% by weight polyethylene).

In some embodiments, a multilayer film of the present invention exhibits a bending stiffness of 1.35 mN·mm or less when the film has a thickness of 2 mils (50.8 microns) when measured according to the method described in the Test Methods section herein. A multilayer film of the present invention, in some embodiments, exhibits a bending stiffness of 1.25 mN·mm or less when the film has a thickness of 2 mils (50.8 microns). In some embodiments, a multilayer film of the present invention exhibits a bending stiffness of 1.15 mN·mm or less when the film has a thickness of 2 mils (50.8 microns).

In some embodiments, a multilayer film of the present invention exhibits a Gelbo flex crack performance of 2 pinholes or less in 20,000 cycles. In some embodiments, a multilayer film of the present invention exhibits a bending stiffness of 1.25 mN·mm or less when the film has a thickness of 2 mils (50.8 microns) and a Gelbo flex crack performance of 2 pinholes or less in 20,000 cycles. In some embodiments, a multilayer film of the present invention exhibits a bending stiffness of 1.15 mN·mm or less when the film has a thickness of 2 mils (50.8 microns) and a Gelbo flex crack performance of 2 pinholes or less in 20,000 cycles.

Various embodiments of multilayer films of the present invention may exhibit one or more of the foregoing properties.

For example, in some embodiments, a multilayer film comprises a first skin layer having an overall density of less than or equal to 0.912 g/cm³; a second skin layer having an overall density of less than or equal to 0.912 g/cm³; and a core positioned between the skin layers, wherein the core has an overall density that is at least 0.01 g/cm³ greater than then overall density of the first skin layer, wherein the overall density of the multilayer film is from 0.905 to 0.930 g/cm³, wherein the film has a bending stiffness of 1.25 mN·mm or less when the film has a thickness of 2 mils (50.8 microns), wherein the film exhibits a Gelbo flex crack performance of 2 pinholes or less in 20,000 cycles, and wherein the film comprises at least 95% by weight polyethylene based on the total weight of the film.

As another example, in some embodiments, a multilayer film comprises a first skin layer comprising a polyethylene plastomer or polyethylene elastomer, wherein the first skin layer has an overall density of less than or equal to 0.912 g/cm³; a second skin layer having an overall density of less than or equal to 0.912 g/cm³; and a core positioned between the skin layers, wherein the core has an overall density that is at least 0.01 g/cm³ greater than then overall density of the first skin layer, wherein the overall density of the multilayer film is from 0.905 to 0.930 g/cm³, wherein the film has a bending stiffness of 1.35 mN·mm or less when the film has a thickness of 2 mils (50.8 microns), wherein the film exhibits a Gelbo flex crack performance of 2 pinholes or less in 20,000 cycles, and wherein the film comprises at least 95% by weight polyethylene based on the total weight of the film.

As another example, in some embodiments, a multilayer film comprises a first skin layer comprising a polyethylene plastomer or polyethylene elastomer, wherein the first skin layer has an overall density of less than or equal to 0.912 g/cm³; a second skin layer comprising a polyethylene plastomer or polyethylene elastomer, wherein the second skin layer has an overall density of less than or equal to 0.912 g/cm³; and a core positioned between the skin layers, wherein the core has an overall density that is at least 0.01 g/cm³ greater than then overall density of the first skin layer, wherein the overall density of the multilayer film is from 0.905 to 0.930 g/cm³, wherein the film has a bending stiffness of 1.35 mN·mm or less when the film has a thickness of 2 mils (50.8 microns), wherein the film exhibits a Gelbo flex crack performance of 2 pinholes or less in 20,000 cycles, and wherein the film comprises at least 95% by weight polyethylene based on the total weight of the film.

As another example, in some embodiments, a multilayer film comprises a first skin layer comprising a polyethylene plastomer or polyethylene elastomer, wherein the first skin layer has an overall density of less than or equal to 0.912 g/cm³; a second skin layer comprising a polyethylene plastomer or polyethylene elastomer, wherein the second skin layer has an overall density of less than or equal to 0.912 g/cm³; and a core positioned between the skin layers, wherein the core has an overall density that is at least 0.01 g/cm³ greater than then overall density of the first skin layer, wherein the overall density of the multilayer film is from 0.905 to 0.930 g/cm³, wherein the film has a bending stiffness of 1.35 mN·mm or less when the film has a thickness of 2 mils (50.8 microns), wherein the film exhibits a Gelbo flex crack performance of 2 pinholes or less in 20,000 cycles, wherein the film comprises at least 95% by weight polyethylene based on the total weight of the film, and wherein the first and the second skin layer each comprise a blend comprising (i) a first polydimethylsiloxane having a number average molecular weight (Mₙ) from 30,000 g/mol to less than 300,000 g/mol and (ii) a second polydimethylsiloxane having a number average molecular weight (Mₙ) from 300,000 g/mol to 2,000,000 g/mol, wherein each skin layer comprises from 0.01 to 2.5 weight percent of the first polydimethylsiloxane based on the total weight of the skin layer and from 0.05 to 4.95 weight percent of the second polydimethylsiloxane based on the total weight of the skin layer.

Multilayer films can be coextruded as blown films or cast films using techniques known to those of skill in the art based on the teachings herein. In particular, based on the compositions of the different film layers disclosed herein, blown film manufacturing lines or cast film manufacturing lines can be configured to coextrude multilayer films of the present invention in a single extrusion step using techniques known to those of skill in the art based on the teachings herein. In some embodiments, the multilayer films are coextruded blown films.

### Articles

Embodiments of the present invention also comprise articles, such as packages, formed from or incorporating multilayer films of the present invention. Such packages can be formed from any of the inventive multilayer films described herein.

Examples of such articles can include flexible packages, pouches, stand-up pouches, and pre-made packages or pouches. In some embodiments, multilayer films or laminates of the present invention can be used for food packages. Examples of food that can be included in such packages include meats, cheeses, cereal, nuts, juices, sauces, and others. Such packages can be formed using techniques known to those of skill in the art based on the teachings herein and based on the particular use for the package (e.g., type of food, amount of food, etc.).

One example of an article that can be formed from any of the inventive multilayer films described herein is a large bag. In some embodiments, such bags have a volume of at least 250 gallons. Such bags, in some embodiments, have a volume up to about 6,000 gallons. In some embodiments, such bags can be used in bag-in-box flexible liquid packages (“BIB packages”). Such bags can be used for a wide variety of liquids.

### Test Methods

Unless otherwise indicated herein, the following analytical methods are used in describing aspects of the present invention:

### Melt Index

Melt indices I₂ (or I2) and I₁₀ (or I10) were measured in accordance to ASTM D-1238 (method B) at 190° C. and at 2.16 kg and 10 kg load, respectively. Their values are reported in g/10 min.

### Density

Samples for density measurement were prepared according to ASTM D4703. Measurements were made, according to ASTM D792, Method B, within one hour of sample pressing.

### Differential Scanning Calorimetry (DSC)

Differential Scanning calorimetry (DSC) can be used to measure the melting, crystallization, and glass transition behavior of a polymer over a wide range of temperature. For example, the TA Instruments Q1000 DSC, equipped with an RCS (refrigerated cooling system) and an autosampler is used to perform this analysis. During testing, a nitrogen purge gas flow of 50 ml/min is used. Each sample is melt pressed into a thin film at 190° C.; the melted sample is then air-cooled to room temperature (25° C.). A 3-10 mg, 6 mm diameter specimen is extracted from the cooled polymer, weighed, placed in a light aluminum pan (50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C. and held isothermal for 3 minutes in order to remove its thermal history. Next, the sample is cooled to −80° C. at a 10° C./minute cooling rate and held isothermal at −80° C. for 3 minutes. The sample is then heated to 180° C. (this is the “second heat” ramp) at a 10° C./minute heating rate. The cooling and second heating curves are recorded. The values determined are extrapolated onset of melting, Tm, and extrapolated onset of crystallization, Tc. Heat of fusion (Hf) (in Joules per gram), the calculated % crystallinity for polyethylene samples using the following equation: % Crystallinity=((Hf)/292 J/g)×100; and the calculated % crystallinity for polyethylene samples using the following equation: % Crystallinity=((Hf)/292 J/g)×100. The heat of fusion (Hf) and the peak melting temperature are reported from the second heat curve. Peak crystallization temperature is determined from the cooling curve.

Melting point, Tm, is determined from the DSC heating curve by first drawing the baseline between the start and end of the melting transition. A tangent line is then drawn to the data on the low temperature side of the melting peak. Where this line intersects the baseline is the extrapolated onset of melting (Tm). This is as described in Bernhard Wunderlich, The Basis of Thermal Analysis, in Thermal Characterization of Polymeric Materials 92, 277-278 (Edith A. Turi ed., 2d ed. 1997).

### GPC-Triple Detector (PDMS Mw and Mn Measurement)

Weight average molecular weight (Mw) and number average molecular weight (Mn) of the polydimethylsiloxane are measured by GPC (Viscotek™ GPC Max) using a triple detection capability. The Viscotek™ TDA305 unit is equipped with a differential refractometer, an online differential pressure viscometer, and low angle light scattering (LALS: 7° and 90° angles of detection). The mobile phase is Toluene HPLC grade. The columns are two PL Gel Mixed C from Varian—(7.5*300 mm, 5 μm particle size) and a PL Gel Guard column from Varian—(7.5*300 mm) 5 fractom Injection volume with a flow of 1 mL/min and a run time of 37 min. The column and detector temperature is 40° C. The software used is Omnisec 4.6.1 (Viscotek™).

The detectors are calibrated by injection of a narrow polystyrene standard (Mw 68,100 g/mol) of a known concentration. Correct run parameters are checked by using a narrow molecular weight distribution polystyrene standard (PS71K). The molecular weight averages must be within the Statistical Process Control (SPC) chart in order to validate the detectors calibration. Typical GPC³ precision and accuracy (which depends on the refractive index increment) are around 2-3%.

### Bending Stiffness

Bending stiffness of multilayer films is calculated based on the principles described by Barry A. Morris and John D. Vansant in “The Influence of Sealant Modulus on the Bending Stiffness of Multilayer Films”, presented at the 1997 TAPPI Polymers, Laminations and Coatings Conference held in Toronto, Ontario, Canada on Aug. 24-28, 1997 and published at pages 165-172 of the Conference Proceedings; the paper also later presented at the Society of Plastics Engineers ANTEC Conference, May 1998 and published at pages 35-40 of the Conference Proceedings; and the paper additionally published in the journal Packaging Technology and Engineering (Barry A. Morris and John D. Vansant, “Sealant Modulus in Multilayer Films Can Skew Bending Stiffness”, Packaging Technology and Engineering, Vol. 7, No. 5, 46-51 (May, 1998)).

The bending stiffness or stiffness factor of a multilayer film, being deflected by D, under an applied force F can be described by:

$$\frac{F}{D} = ( {\sum }_{i = 1}^{n} {E}_{i} {I}_{i} ) {G}^{′} .$$

wherein Eᵢ=modulus of layer I, Iᵢ=contribution to the total moment of inertia from layer I, n=number of layers and G′=describes how the force is applied. ΣEᵢIᵢ represents a bending stiffness describing the composite stiffness of the beam, film, sheet, etc. ΣEᵢIᵢ, the bending stiffness, is calculated by first locating the neutral axis and then the contribution of each layer based on the distance of the layer to the neutral axis.

### Gelbo Flex Crack Performance

The Gelbo flex crack performance is measured using a Gelbo flex tester set up to test in accordance with ASTM F392.

Some embodiments of the invention will now be described in detail in the following Examples.

### EXAMPLES

The following examples illustrate the present invention, but are not intended to limit the scope of the invention.

The raw materials shown in Table 1 are used to prepare the Inventive Films and Comparative Films discussed below. Each of the resins are commercially available from The Dow Chemical Company unless noted otherwise.

TABLE 1

| | | I₂ | Density |
|---|---|---|---|
| Commercial Name | Type | (g/10 min) | (g/cc) |
| AFFINITY ™ PL 1880 G | Polyolefin Plastomer | 1.0 | 0.902 |
| DOWLEX ™ 2045 | LLDPE | 1.0 | 0.920 |
| ENGAGE ™ 8180 | Polyolefin Elastomer | 0.5 | 0.863 |
| INNATE ™ ST50 | Ethylene-based Polymer | 0.85 | 0.918 |
| INNATE ™ TH60 | Ethylene-based Polymer | 0.85 | 0.912 |
| MB25-502 Masterbatch* | LDPE A MI (I₂)(190° | | |
| (25 wt % dimethylhydroxysilyl terminated | C./2.16 kg) = 8.0 g/10 min | | |
| PDMS (PDMS A) dispersed in LDPE A) | PDMS A Mn = 48,400 g/mol | | |
| | PDMS A Mw = 120,100 g/mol | | |
| | PDMS A Mw/Mn = 2.48 | | |
| MB50-613 Masterbatch* | LLDPE A MI (I₂)(190° | | |
| (50 wt % dimethylvinylsilyl terminated | C./2.16 kg) = 6.0 g/10 min | | |
| PDMS (PDMS B) dispersed in LLDPE A) | PDMS B Mn = 356,700 g/mol*** | | |
| | PDMS B Mw = 647,266 g/mol*** | | |
| | PDMS B Mw/Mn = 1.82*** | | |
| ME 50024 Masterbatch** | LDPE B MI (I₂)(190° | | |
| (62.5 wt % talc dispersed in LDPE B) | C./2.16 kg) = 20 g/10 min | | |
| Antiblock | Silica | | |

*commercially available from Dow Corning
**commercially available from Multibase S.A.
***based on the average of 3 samples

### Inventive Films 1-2 and Comparative Films A-E

Inventive Films 1-2 and Comparative Films A-E are three-layer (A/B/A) coextruded films that are prepared as follows. The thicknesses of the layers (A/B/A) are 20%/60%/20%, except for Comparative Film D which is 30%/40%/30% and Comparative Film E which is 40%/20%/40%. Inventive Films 1-2 and Comparative Films A-E have the following structures:

TABLE 2

| Film | Structure |
|---|---|
| Inventive | A: 100% AFFINITY ™ PL 1880G |
| Film 1 | B: 100% INNATE ™ ST50 |
| Inventive | A (0.903 g/cm³): 95.75% AFFINITY ™ PL 1880G |
| Film 2 | 1.125% LDPE A (from MB25-702 Masterbatch) |
| | 0.1875% LDPE B (from ME 50024 Masterbatch) |
| | 1.125% LLDPE A (from MB50-613 Masterbatch) |
| | 0.375% PDMS A(from MB25-702 Masterbatch) |
| | 1.125% PDMS B (from MB50-613 Masterbatch) |
| | 0.3125% Talc (from ME 50024 Masterbatch) |
| | B: 100% INNATE ™ ST50 |
| Comparative | A: 100% INNATE ™ TH60 |
| Film A | B: 100% ENGAGE ™ 8180 |
| Comparative | A (0.902 g/cm³): 99.7% AFFINITY ™ PL 1880G |
| Film B | 3000 ppm Antiblock |
| | B: 100% INNATE ™ ST50 |
| Comparative | A: 100% INNATE ™ TH60 |
| Film C | B: 100% INNATE ™ TH60 |
| Comparative | A: 100% INNATE ™ TH60 |
| Film D | B: 100% AFFINITY ™ PL 1880G |
| Comparative | A: 100% DOWLEX ™ 2045 |
| Film E | B: 100% ENGAGE ™ 8180 |

The overall densities of the layers that are not 100% resin are provided in parentheses next to the layer label (e.g., “A (0.903 g/cm³)”).

The films are produced using a LabTech coextrusion blown film line. The line was comprised of five 30:1 L/D single screw extruders, equipped with smooth feed zones. Screw diameters are 25 mm for the two outer layer extruders and 20 mm for the three core layer extruders. The die is 74.9 mm, and the die gap is 2 mm. The melt temperature is 430° F. The blow-up ratio is 2.5:1. The output rate is 20 pounds/hour/inch. The nominal thickness of each film is 2 mils.

The overall film density is calculated. The bending stiffness and the Gelbo flex crack performance are measured using the test methods described above (Gelbo flex crack performance is reported as “Defects”). The results are shown in Table 3.

TABLE 3

| | Film Density | | Bending Stiffness |
|---|---|---|---|
| Film | (g/cm³) | Defects | (mN · mm) |
| Inventive | 0.9116 | 0 | 1.00 |
| Film 1 | | | |
| Inventive | 0.912 | 0.67 | 1.04 |
| Film 2 | | | |
| Comparative | 0.8826 | 0 | 1.08 |
| Film A | | | |
| Comparative | 0.9116 | 6.67 | 1.00 |
| Film B | | | |
| Comparative | 0.912 | 4.5 | 1.37 |
| Film C | | | |
| Comparative | 0.908 | 3 | 1.33 |
| Film D | | | |
| Comparative | 0.9086 | 18 | 2.08 |
| Film E | | | |

Inventive Films 1 and 2 both have overall film densities of ≥0.910 g/cm³, which is an indicator of machinability while also having excellent Gelbo flex crack performance (≤2). Comparative Film A has good Gelbo flex crack performance but a much lower overall film density. Comparative Film C has a comparable overall film density, but a higher number of defects. Relative to Comparative Film B, Inventive Film 2 shows that the inclusion of PDMS improves Gelbo flex crack performance. Comparative Films D and E have lower overall film densities relative to Inventive Films 1 and 2 but do not match their performance which further illustrates the surprising results of the present invention.

1. A multilayer film comprising:
a first skin layer having an overall density of less than or equal to 0.912 g/cm³;
a second skin layer having an overall density of less than or equal to 0.912 g/cm³; and
a core positioned between the skin layers, wherein the core has an overall density that is at least 0.01 g/cm³ greater than then overall density of the first skin layer,
wherein the overall density of the multilayer film is from 0.905 to 0.930 g/cm³, wherein the film has a bending stiffness of 1.35 mN·mm or less when the film has a thickness of 2 mils (50.8 microns), wherein the film exhibits a Gelbo flex crack performance of 2 pinholes or less in 20,000 cycles, and wherein the film comprises at least 95% by weight polyethylene based on the total weight of the film.

2. The multilayer film of claim 1, wherein the second skin layer has the same composition as the first skin layer.

3. The multilayer film of claim 1, wherein the first skin layer comprises a polyethylene plastomer or polyethylene elastomer.

4. The multilayer film of claim 1, wherein the second skin layer comprises a polyethylene plastomer or polyethylene elastomer.

5. The multilayer film of claim 1, wherein at least one skin layer further comprises from 0.5 wt % to 5.0 wt % polydimethylsiloxane, based on the total weight of the skin layer.

6. The multilayer film of claim 1, wherein at least one skin layer further comprises a blend comprising (i) a first polydimethylsiloxane having a number average molecular weight (Mₙ) from 30,000 g/mol to less than 300,000 g/mol and (ii) a second polydimethylsiloxane having a number average molecular weight (Mₙ) from 300,000 g/mol to 2,000,000 g/mol, wherein the skin layer comprises from 0.01 to 2.5 weight percent of the first polydimethylsiloxane based on the total weight of the skin layer and from 0.05 to 4.95 weight percent of the second polydimethylsiloxane based on the total weight of the skin layer.

7. The multilayer film of claim 1, wherein the thickness of the core comprises up to 80% of the thickness of the multilayer film.

8. The multilayer film of claim 1, wherein the multilayer film is a three layer film.

9. The multilayer film of claim 1, wherein the core comprises two or more layers.

10. The multilayer film of claim 1, further comprising an olefin block copolymer in at least one of the layers.

11. The multilayer film of claim 1, wherein the overall thickness of the film is from 1 mil (25.4 microns) to 10 mils (254 microns).

12. An article comprising a multilayer film according to claim 1.

13. A bag having a volume of at least 250 gallons comprising a multilayer film according to claim 1.
